(19) United States
(12) Patent Application Publication
(10) Pub. No.: US 2005/0187821 A1
(43) Pub. Date: Aug. 25, 2005

(54) Reusable discount card and prescription drug compliance system

(76) Inventor: Joshua Lapsker, Christ Church (BB)

Correspondence Address: KLAUBER & JACKSON, 411 HACKENSACK AVENUE, HACKENSACK, NJ, 07601, US

(21) Appl. No.: 10/785,930

(22) Filed: Feb. 24, 2004

(51) Int. Cl. G06F 17/60

(52) U.S. Cl. 705/14

(57) ABSTRACT

A prescription drug compliance and reusable discount system provides reminders and offers the incentives to patients to continue the taking of prescription medications.

### BACKGROUND AND SUMMARY OF THE INVENTION

While prescription drugs are modern miracles in preserving and extending a person's life, not taking prescriptions as required (non-compliance) has become a major health problem. Additionally, people who may be only partially insured (such as the elderly), or wholly uninsured (such as lower income populations), or those that are too busy or forgetful in their daily lives to procure medications, are prone to discontinue or to not fill prescriptions as directed.

Non-compliance in prescription drug taking is putting an enormous strain on the entire health care system today. Estimates of cost to the United States economy range from 50 to as high as 100 billion dollars per year. It is estimated that 17 percent of all Emergency room visits are the direct result of a prescription drug misdirection (non-compliance). Other results of non-compliance include hospital and nursing home admissions, as well as lost wages and lower productivity. Moreover, the most pressing aspect of non-compliance is reflected in the fact that compliance drops off dramatically when it comes time to refill a prescription. It is known by insurance estimates that for ongoing prescriptions, after one year from beginning a prescription regimen, approximately 60% of patients no longer continue taking or refilling the required medication. This represents an unhealthy dynamic that costs both employers, insurance companies, and society at large greatly over time.

As the population ages, non-compliance becomes a source for even more concern. Population experts say by the year 2003, 83 million Americans will be over the age of 50, and by the year 2010, that figure will be over 100 million. In addition, as prescription drugs become more expensive, and as government and employer funded coverage for such drug plans becomes less comprehensive, compliance becomes even more so of a concern for doctors who are concerned about their patients following through with treatments, for insurance companies who wish to reduce the resulting costs of non-compliance, and for patient who yearn for a less expensive form of compliance.

Currently no system exists to assure discounted, long-term compliance in the taking of prescription drugs. Known compliance systems have provided for various methods of notification to ensure compliance. Various methods of such notification include pager systems such as U.S. Pat. No. 5,623,242, cable set top boxes for use in homes, assisted living centers, retirement centers, nursing homes, hotels and adult day care centers, such as those detailed in U.S. Pat. No. 5,512,935, U.S. Pat. No. 5,649,283, U.S. Pat. No. 5,631,903, U.S. Pat. No. 5,727,052, and/or more sophisticated variants such as telephone or wireless systems such as those described by U.S. Pat. Nos. 5,963,136, and 6,150,942, all of which are incorporated by reference herein, are useful for enabling the broadcasting of reminders and/or ensuring that a medication has been actually taken by a patient. Prior art systems are therefore aimed at providing “strong arm” tactics, such as annoying messages on pagers, set top boxes and the like, without providing a means to attack the root of the problem in non-compliance, which is motivation, a factor of which is often diminished by financial concerns. While these systems may possibly provide some form of compliance, none actually encourage or motivate a patient through financial incentives to comply with filling a drug prescription and to refill subsequently as directed. However, none of these systems provide both a means of notification and an incentive for a given prescription medication to be taken. Moreover, none of these systems are aimed at tackling the problem of long term compliance.

As such, if a means were developed to motivate, rather than merely remind patients to take a prescribed medication, then compliance, especially on a long term basis, would be greatly enhanced. Any financial cost involved in such a system would be vastly outweighed by the cost savings for the care of chronically ill patients and the growing aged population.

Accordingly, the present invention relates to the purchasing and taking of prescription drugs through an incentive based compliance system. The system incorporates third party monitoring stemming from an initial participation decision by a patient who has been influenced by the prospect of ongoing (e.g., multiple use) discount for a given prescription. Medical monitoring and financial incentives for all parties (patient, insurer, etc.) are additional benefits to this invention.

### BRIEF DESCRIPTION OF THE DRAWINGS

FIG. 1 is a depiction of an exemplary reusable discount card and solicitation/sign up contemplated by the inventive system;

FIG. 2 is a rendering of the major connected elements of the inventive reusable discount card and prescription drug compliance system; and

FIG. 3 is a flowchart detailing an exemplary process that might be employed in executing the inventive method and functions of the system.

### DETAILED DESCRIPTION OF THE DRAWINGS AND PREFERRED EMBODIMENTS

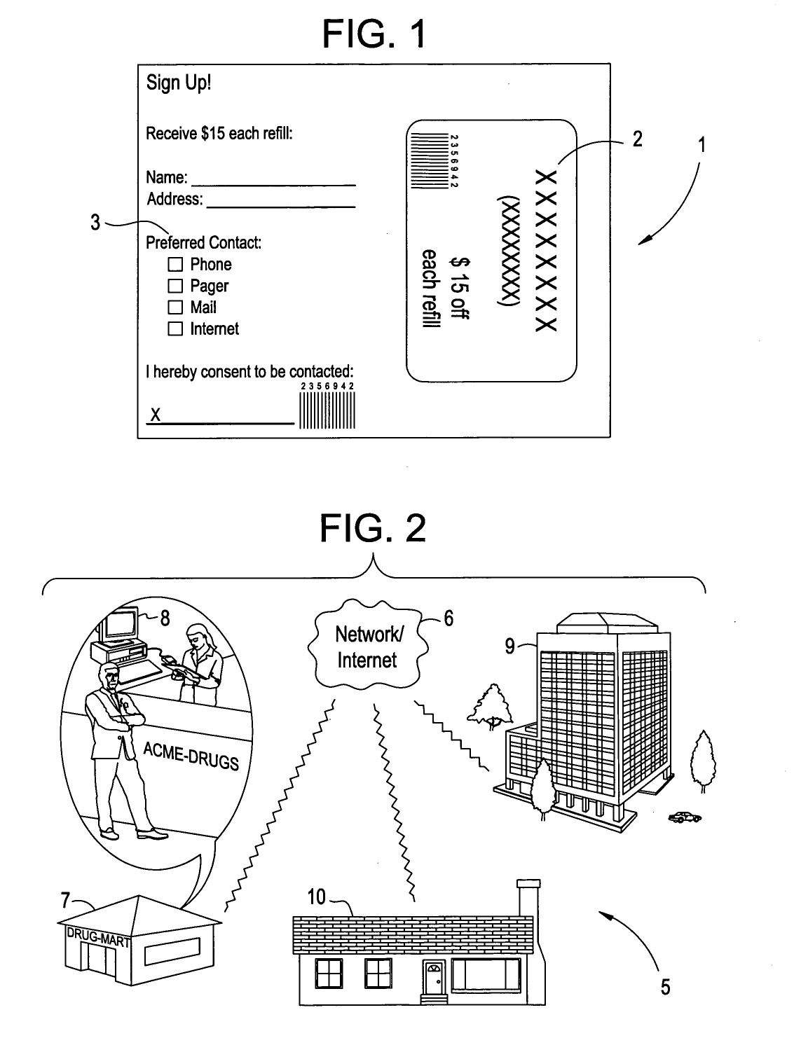

FIG. 1 depicts the reusable discount card 2 and the solicitation/sign up portion 3 together forming one detachable unit on an informational backing 1 of the inventive reusable discount card and prescription drug compliance system. Although many variants of the reusable discount card 2 and solicitation/sign up portion 3 may be envisioned, in one preferred embodiment, the reusable discount card 2 will be a standard plastic card, preferably attached by gum like glue to an informational backing 1, and will have printed product information, discount information, and a unique identifier and transaction code means (such as a bar code, smart chip, and/or magnetic stripe, etc.). Such a unique identifier and transaction code means will be one of the preferred ways of activating and tracking the discount card usage. Where the unique identifier and transaction code means is say, a bar code, such activation and subsequent card usage may be tracked by the use of a common bar code scanner device well known in the art of retailing and cash register technologies. Where a patient consents to enrolling in the discount compliance program, his name, address, signature, preferred means of receiving future reminders, and other information can be received (either directly by a clerk 8 at a pharmacy 7 or a doctor's office where the prescription is initialized/filled, or indirectly, by mail or other means, by a customer service center 9) into a database (not depicted) (either through manual data entry input, or through form-based scanning as known in the art). The solicitation/sign up portion will typically have a code that has been recorded at the time of printing for identifying the type of prescription drug (and refill specifics as needed), and will most preferably have a corresponding way of correlating the unique identifier and transaction code means with the solicitation/sign up portion 3, such as by an including of a matching serial number or matching bar code.

FIG. 2 shows the major elements of the system. Ideally, the pharmacy/doctor's office 7 and customer service center 9 will be connected to each other via some form of network means, such as the internet, where they can communicate in real time as needed, or where they can just send patient data to each other as needed through regularized, periodic transmission of updated data. Where the patient has indicated a preference for internet (email) or set top box notification, there will be an internet, cable or other network type connection with the patient's residence 10.

By way of more specific illustration, the process within the inventive system might begin with the patient's doctor writing a prescription, and the doctor (or even the pharmacist thereafter) would hand him the sign up/consent 3 and the attached reusable discount card 2. The patient's doctor would write the prescription containing the following information: patient's name, doctor's name, drug name indicating whether or not generic replacement is acceptable, drug strength, drug quantity, SIG (dosage intervals). The pharmacist would then receive the prescription and the reusable card 2 and the completed solicitation sign up card 3 (or at least the raw data therefrom, if done remotely, rather than in-person) for the first filling of a given prescription. The pharmacist typically requires the following in addition to information provided on prescription form: patient's address, patient telephone number, date of birth and sex, which would be provided by the patient orally, in writing, or through a readable insurance card. The pharmacist would then create the following information: prescription number, refill number, date filled. All of this information is entered into the pharmacy data entry workstations 8. The entire patient prescription can be formed as a data packet, and can be sent to the customer service center 9 via the network, instantly through an established communication link such as satellite, frame relay, PSTN, LAN or WAN or POTS. Other patient information may be stored in the filling pharmacy/dispensary database as needed. In an especially preferred embodiment, an interactive communication link between the data processing center and the Customer Service Center would be a dedicated T2 type or better, or satellite connection. The pharmacy/dispensary 7 could then download all patient doctor prescription insurance, to the customer service center 9 in real time. Depending on the required specifics, the following data might then be received at the customer service center 9: patient's name, age, sex, prescription number; doctor's name, address, telephone number; dosage amount and time of day; number of refills; drug type; quantity; date and time prescription bought or received; primary care giver name, address and phone number; preferred communication methodology (interactive/audio visual set top box number; cellular or land line phone number; pager serial number; billing method (credit card, check or cash); insurance company/Medicare/Medicaid; and proof of consent. Alternatively, however, this data could be compressed, packetized and transmitted to the customer service center 9 via frame relay, PSTN, POTS, LAN, WAN, and Satellite transmission lines could be used. Nightly procedures for both the retail pharmacy and the mail order pharmacy would ideally be to download the prescription data from the pharmacy data entry work station to a store or mail order pharmacy server. The download to the data processing center could occur at off-peak hours after close of business.

Either way, the customer service center 9 (ideally a third party contractor) would preferably be the central location of all patient, doctor, prescription, insurance, bar code or magnetic strip data. This allows the modern pharmacy chain store and pharmaceutical mail order facilities to secure nationwide central data storage, and provide a central clearing house for insurers and/or pharmaceutical manufacturers to coordinate drug specific discount transactions as needed. Also, the customer service center would verify that a given card being used has not expired or exceeded the maximum allowable multiple discounts provided for (typically two years maximum), although this limit will ultimately be dependent on the specific business model needed for the specific drug(s) that the card has been issued.

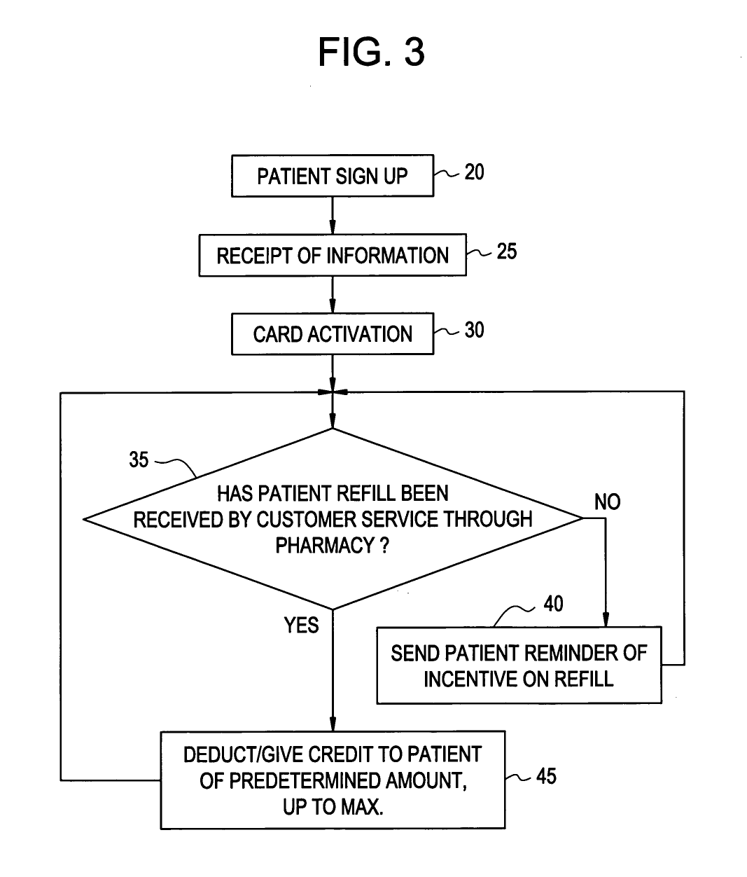

FIG. 3 illustrates, in flow diagram form, the theory of operation, beginning with patient sign up 20, the prompting of receipt of information 25, which leads to card activation 30, all of which may be logistically accomplished as described above. As detailed above, once a patient has filled an initial prescription, the patient will sign up and the card will be initialized, either immediately, or afterwards through the mail, or by calling customer service center 9. In one embodiment, any pharmacy or dispensary will be able to communicate with customer service through phone, or most preferably through the above described network/internet connection where simple software, as known in the art for retailing, has been installed at a pharmacy/dispensary 7 terminal 8 that is commonly used today, so that they may log the scanned and/or input information into a discrete patient record which may be individually sent via electronic mail etc., or periodically as batch processed data as known in the art.

It can then be determined (within the previously transmitted prescription refill information as detailed above) by the automated processing (similar to well known automated billing programs that can check as to whether a payment has been sent in response to a bill) at customer service center 9, whether a refill has been processed 35 by the networked pharmacy/dispensary within the designated refill timeline.

In a most preferred embodiment, when a patient comes to refill a prescription at the networked pharmacy/dispensary 7, then the pharmacy/dispensary 7 will be able to swipe the reusable card 2 at a swipe terminal (not depicted) at a pharmacy/dispensary 7 terminal 8, and much like swipe technology that is currently well known in the art of credit card processing, a magnetic strip is provided on the reusable card 2 so that it can be read by the swipe terminal, such that the refill transaction can be immediately transmitted to the automated processing at customer service center 9. Thereafter, the predetermined stated on the given card discount (the amount and duration of which is necessarily different for each type of medication, depending on manufacturer terms, and the specifics of which are ideally encoded within the magnetic strip on the back of the card) can be immediately applied, step 45, as needed, to the payment that may be required at that particular time from the patient.

In one alternative embodiment, in lieu of in person presentation at a pharmacy/dispensary, the present invention provides for the card to be used over the phone or through the mail as is currently popular when filling prescriptions. In such cases, rather than utilizing a scan, the bar code number or other serial number may be written down on a refill form for mailing to customer service center 9, input on a web page form on the internet for transmission to customer service center 9, or may be communicated over the phone to a live representative or to a voice activated automated system at customer service center 9. Based on the original printing described above that recorded the bar code/serial number, the amount of discount could be accounted for by the automated system of the customer service center when payment is required during the transaction.

However, if the refill has not been processed within the refill time period, then an automated reminder 40 can be sent to the patient via the means designated by the patient originally on the solicitation/sign up portion 3. The automated reminder, as suggested earlier, could be conveyed in any one (or several) types of means preferred by the patient. If the user does not refill the prescription after two (2) reminder attempts by the customer service center 9, the primary caregiver may be notified, if required by the insurer. This action would ensure the user would be in compliance. Dates, times of non-compliance, as well as caregiver notification might, in certain embodiments, all be recorded in a customer service center 9 database.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure. Modification of this method and apparatus can become clear to a person having ordinary skill in this particular art; all such modifications are clearly covered by this disclosure.

1. A prescription drug compliance and discount payment system comprising:
(a) a reusable discount card;
(b) a solicitation input means;
(c) an activation means for activating a patient participation based upon reception of information derived from said solicitation input means; and
(d) a discount and compliance means for ensuring compliance and for awarding incentives to patients.

2. The system of claim 1, wherein said reusable discount card includes a bar code identifier.

3. The system of claim 2, wherein said reusable discount card further includes a readable magnetic strip.

4. The system of claim 1, wherein said discount and compliance means includes ongoing incentives.

5. The system of claim 4, wherein said ongoing incentives are tailored to match a specific prescription being filled, and to match patient preferences.

6. A method of ensuring prescription drug compliance by offering discounts, said method comprising:
(a) issuing a reusable discount card to a patient having a prescription need;
(b) obtaining patient participation consent and personalized patient information pertaining to said prescription need;
(c) activating an ongoing patient compliance account for a determined time period; and
(d) ensuring compliance with certain terms of said prescription need by issuance of ongoing incentives.

7. The method of claim 6, wherein said incentives are monetary discounts on a price assigned to a given prescription need.

8. The method of claim 6, wherein said determined time period is no more than two years from the activation of said patient compliance account.

9. The method of claim 6, wherein said compliance is ensured by sending reminders via a preferred communication means to the patient when a refill time limit has been exceeded.
